(19) United States
(12) Patent Application Publication
(10) Pub. No.: US 2026/0030830 A1
(43) Pub. Date: Jan. 29, 2026

(54) METHOD FOR RAY TRACING, ELECTRONIC DEVICE AND CHIP

(71) Applicant: INNOPEAK TECHNOLOGY, INC., Palo Alto, CA (US)

(72) Inventors: Xiaoyu YE, Palo Alto, CA (US); Chen LI, Palo Alto, CA (US); Qiang QIU, Palo Alto, CA (US); Hongyu SUN, Palo Alto, CA (US)

(21) Appl. No.: 19/123,642

(22) PCT Filed: Oct. 26, 2023
(86) PCT No.: PCT/US2023/036024

§ 371 Date: Apr. 23, 2025

Related U.S. Application Data
(60) Provisional application No. 63/419,422, filed on Oct. 26, 2022.

(51) Int. Cl. G06T 15/06; A63F 13/52; G06T 15/04; G06T 15/50; G06T 15/80

(52) U.S. Cl. CPC G06T 15/06; A63F 13/52; G06T 15/04; G06T 15/506; G06T 15/80; A63F 2300/66; A63F 2300/8082

(57) ABSTRACT

A method for ray tracing is executed by an electronic device. Game objects are added to a ray tracing world class associated with a scene. Materials of the game objects are added to the ray tracing world class. Light configuration is added to the ray tracing world class. Ray tracing effects are rendered for at least one portion of the game objects in the scene based on the ray tracing world class and stereo views of the scene including the game objects are generated. An electronic device and a chip are also provided.

### CROSS-REFERENCE TO RELATED APPLICATIONS

This application is a national stage of International application no. PCT/US2023/036024, filed on Oct. 26, 2023, which claims the benefit of priority to U.S. Provisional Application No. 63/419,422, filed on Oct. 26, 2022. All of them are hereby incorporated in their entireties by this reference.

### BACKGROUND OF DISCLOSURE

### Field of Disclosure

The present disclosure relates to the field of artificial reality, and more particularly, to a method for ray tracing, an electronic device and a chip.

### Description of Related Art

Technologies relating to extended reality (XR), such as virtual reality (VR), augmented reality (AR), mixed reality (MR), and the like, have made rapid progress. A system implementing an artificial-reality technology can include a device that allow digitally produced virtual objects, such as 3D virtual objects, to be located in a 3D scene or to be overlaid in an image of a real-world environment, along with objects from the real-world environment.

### Technical Problem

Implementing ray tracing in real-time applications, be it on PC-based or all-in-one VR devices, typically demands formidable graphics processing unit (GPU) power, making it a challenging task in most scenarios.

Integrating ray tracing technology necessitates substantial coding efforts from developers or designers, often requiring specific environments for successful implementation and integration. Unfortunately, there is no universally user-friendly system or method available.

Executing real-time ray tracing effects with limited computational resources demands optimization in stereo vision, ray tracing algorithms, and pipeline design. However, current solutions often overlook the optimization aspect for real-time scenarios and all-in-one VR devices.

### SUMMARY

Embodiments of the present disclosure provide a method for ray tracing, an electronic device and a chip.

In a first aspect, an embodiment of the disclosure provides a method for ray tracing executable in an electronic device, comprising:
adding game objects to a ray tracing world class associated with a scene;
adding materials of the game objects to the ray tracing world class;
adding light configuration to the ray tracing world class;
rendering ray tracing effects for at least one portion of the game objects in the scene based on the ray tracing world class; and
generating stereo views of the scene including the game objects.

In a second aspect, an embodiment of the disclosure provides an electronic device comprising a processor configured to call and run a computer program stored in a memory, to cause the device to execute the disclosed method and any combination of embodiments of the disclosed method.

In a third aspect, an embodiment of the invention provides a chip including a processor configured to call and run a computer program stored in a memory, to cause a device in which the chip is installed to execute the disclosed method and any combination of embodiments of the disclosed method.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field may obtain other figures according to these figures without paying the premise.

FIG. 1 illustrates a schematic view showing an electronic device used for extended reality (XR).

FIG. 2 illustrates a schematic view showing an example of a personal computer for execution of the disclosed system and method.

FIG. 3 illustrates a schematic view showing an embodiment of a system of the disclosure.

FIG. 4 illustrates a schematic view showing an embodiment of the disclosed method.

FIG. 5 illustrates a schematic view showing an example of a left view and a right view.

FIG. 6 illustrates a schematic view showing an embodiment of a rendering plugin of the disclosure.

FIG. 7 illustrates a schematic view showing another example of a left view and a right view in a scheme of multi-pass rendering.

FIG. 8 illustrates a schematic view showing another example of a left view and a right view in a scheme of multi-view rendering.

FIG. 9 illustrates a schematic view showing a view synthesis using depth image based rendering (DIBR).

FIG. 10 illustrates a schematic view showing a first example of a scene processed by

hybrid rendering with rasterization.

FIG. 11 illustrates a schematic view showing a second example of reducing reflection area based on materials.

FIG. 12 illustrates a schematic view showing a chip for executing the disclosed method.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

TABLE 1

| | |
|---|---|
| API | Application programming interface |
| AR | Augment reality |
| BVH | Bounding volume hierarchy |
| CPU | Central Processing Unit |
| DIBR | Depth Image Based Rendering |
| FBO | frame buffer object |
| GPU | Graphics processing unit |
| MR | Mixed Reality |
| ORM | Object relationship management |
| PC | Personal computer |
| SDK | Software development kit |
| VR | Virtual Reality (VR) |
| XR | Extended Reality |

Embodiments of disclosure provides a new framework to enable ray tracing implementation in XR. A system of the disclosure comprises a native ray tracing software development kit (SDK) designed for mobile device or personal computer (PC). For example, the mobile device may comprise a smartphone, a tablet, or others. The mobile device may execute an embedded operating system (OS), such as Android™.

The system of the disclosure may further comprise a plugin that envelops native functions and exposes them to the game engine. Embodiments of the disclosure provides a methodology tailored for rendering stereo vision in VR and optimizations essential for handling intricate scenes on VR devices.

The ray tracing SDK facilitates real-time ray tracing solutions for both desktop and mobile platforms. To leverage the benefits of the ray tracing SDK for VR, a rendering plugin has been developed to seamlessly integrate the SDK's static libraries and expose application programming interfaces (APIs) accessible for scripts to call from within the game engine.

Furthermore, to meet the demands of VR rendering, which necessitates the creation and rendering of dual views for both the left and right eye cameras, specific methods have been established to generate stereo vision. These methods focus on the creation of dual views to ensure an immersive VR experience.

To seamlessly integrate this system into real-time applications and ensure exceptional visual experiences in VR scenes, several optimization techniques have been incorporated. These optimization techniques involve the utilization of hybrid rendering techniques in rasterization, reduction in the size of shadow maps, limitation of reflection areas based on physical characteristics and materials, as well as the use of mesh space rendering for static scenes, among others.

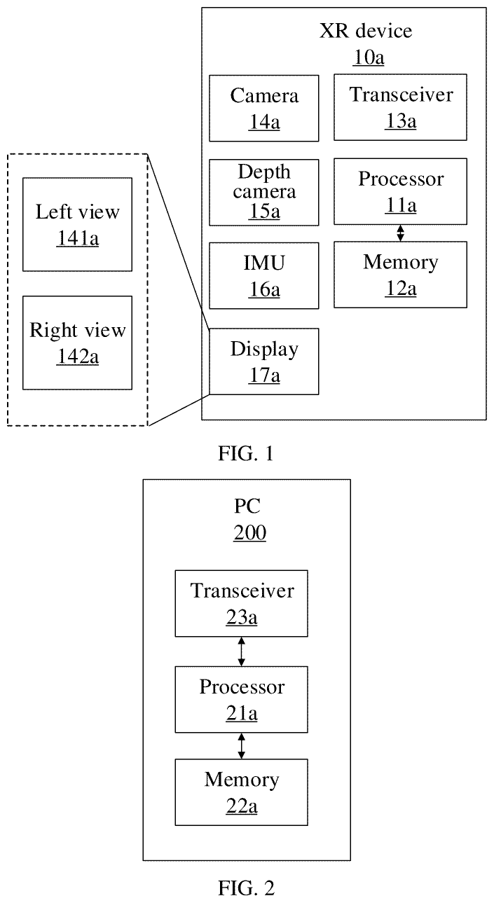

With reference to FIG. 1, a system including XR device 10a. The XR device 10a executes the disclosed method according to an embodiment of the present disclosure. The XR device 10a may be a mobile phone, a PC-based XR device, standalone XR device, AR/VR glasses, or other XR processing devices. FIG. 1 is shown for illustrative not limiting, and the system may comprise more XR devices. Connections between devices and device components are shown as lines and arrows in the FIGs. The XR device 10a may include a processor 11a, a memory 12a, a transceiver 13a, a camera 14a, a depth camera 15a, and an inertial measurement unit (IMU) 16a. The cameras 14a captures and generates color space images from a scene. The depth cameras 15a captures and generates depth images from a scene. The IMU 16a measures and generates external odometry of the device 10a. Odometry of a device is an estimation that uses data from motion sensors to estimate the position change of the device over time. A color space image camera, such as camera 14a, is configured to capture a sequence of input frames, wherein each of the input frames comprises a color space image. A depth camera, such as depth camera 15a, is configured to capture a depth image that is associated with the color space image in each frame. An IMU, such as IMU 16a, is configured to provide external odometry that is associated with the color space image in each frame. In various embodiments, the display 17a may include a display, such as a liquid crystal display and a touch screen display. The display 17a may displays a left view 141a and a right view to realize a stereo view for a user.

The processors 11a may include an application-specific integrated circuit (ASIC), other chipsets, logic circuits and/or data processing devices. The memory 12a may include read-only memory (ROM), a random access memory (RAM), a flash memory, a memory card, a storage medium and/or other storage devices. The transceivers 13a may include baseband circuitry and radio frequency (RF) circuitry. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art.

With reference to FIG. 2, a personal computer (PC) 200 may include a processor 21a, a memory 22a, and a transceiver 23a. The processor 21a is configured to call and run a computer program stored in the memory 22a, to cause PC 200 in which the processor 11 is installed to execute the method, steps, and/or functions of one or more embodiments of the disclosure. The transceiver 23a may include baseband circuitry and radio frequency (RF) circuitry.

The processors 21a may include an application-specific integrated circuit (ASIC), other chipsets, logic circuits and/or data processing devices. The memory 22a may include read-only memory (ROM), a random access memory (RAM), a flash memory, a memory card, a storage medium and/or other storage devices. The transceivers 23a may include network interface card (NIC) or a wireless communication unit, which may comprise baseband circuitry and radio frequency (RF) circuitry. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art.

### System Architecture:

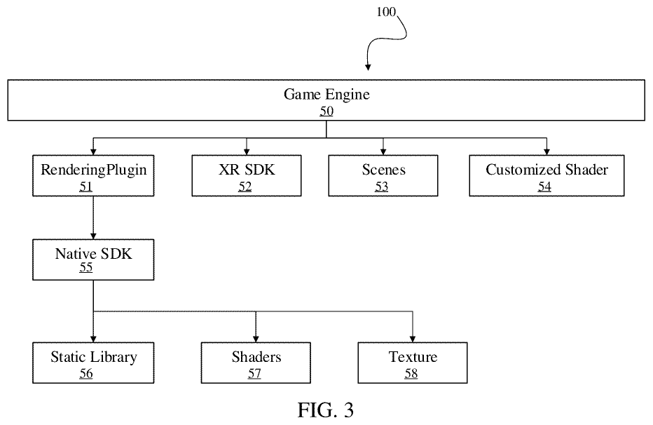

As shown in FIG. 3, a VR ray tracing system 100 comprises a plurality of modules, including a game engine 50, RenderingPlugin 51, XR SDK 52, Scenes 53, Customized shader, Native SDK 55, Static library 56, Shaders 57, and Texture 58. The ray tracing system 100 may be installed and executed by the XR device 10a or the PC 200.

The RenderingPlugin 51 and the native SDK 55 can be seamlessly integrated into or utilized by the game engine 50. The RenderingPlugin 51 is configured to invoke native functions within the native SDK 55 for ray tracing. The native SDK 55 for ray tracing is configured to perform all the essential computations for effects, such as shadows, reflections, and refractions.

The XR SDK 52 is operable to configure camera information and render scenes on VR devices, typically tailored to specific platforms and provided with hardware devices. Example of the XR SDK 52 such as the Oculus™ Plugin and Pico™ XRSDK. Once all the necessary dependencies of game objects are in place, developers can design scenes (e.g., scenes 53) in the game engine 50, cither by importing 3D assets or utilizing the inbuilt editing tools of the game engine 50, just like with non-ray-tracing applications or games. Ultimately, customized shaders 54 that are attached to the game objects will render shadow maps onto the game objects and apply ray tracing effects to the original colors of the game objects.

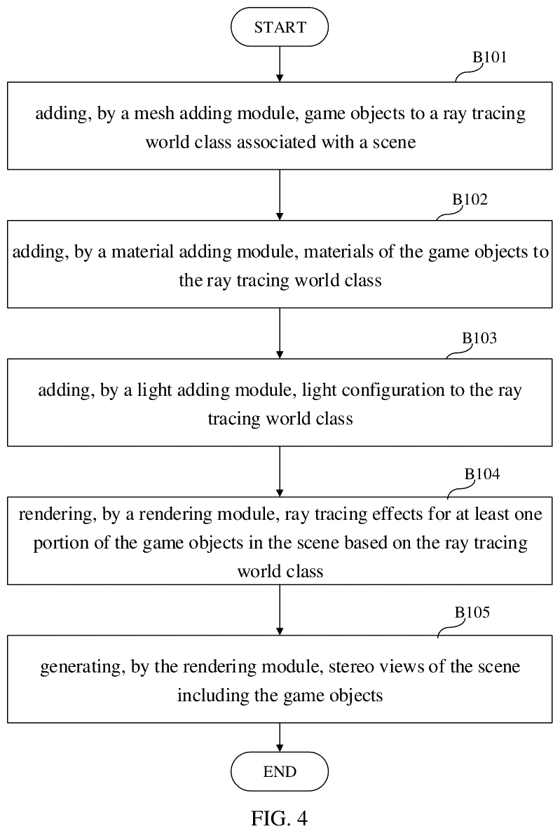

With reference to FIG. 4, an embodiment of the disclosed method for ray tracing comprises:

adding, by a mesh adding module, game objects to a ray tracing world class associated with a scene (B101);

adding, by a material adding module, materials of the game objects to the ray tracing world class (B102);

adding, by a light adding module, light configuration to the ray tracing world class (B103);

rendering, by a rendering module, ray tracing effects for at least one portion of the game objects in the scene based on the ray tracing world class (B104); and

generating, by the rendering module, stereo views of the scene including the game objects (B105).

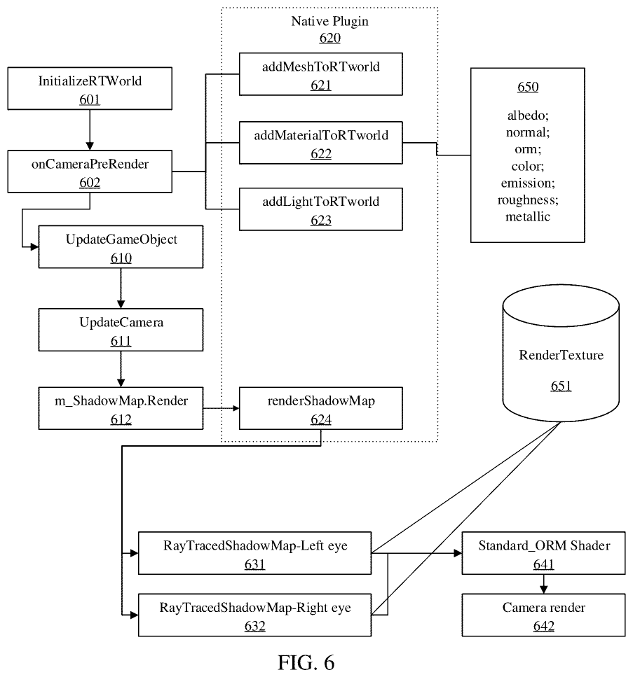

As shown in FIG. 6, in some embodiments of the disclosure, examples of the mesh adding module, material adding module, light adding module, and rendering module comprise addMeshToRTworld 621, addMaterialToRTworld 622, addLightToRTworld 623, and renderShadowMap 624.

In some embodiments of the disclosure, the mesh adding module, the material adding module, the light adding module, and the rendering module are included in a software development kit (SDK). In some embodiments of the disclosure, the SDK is included in a game engine.

In some embodiments of the disclosure, the materials of the game object comprise albedo, normal, object relationship mapping (ORM), color, emission, roughness, and metallic. The light configuration comprises a light source.

In some embodiments of the disclosure, the stereo views are generated in a multi-pass rendering mode in which a game engine renders the scene twice using two draw calls for each of the game object.

In some embodiments of the disclosure, the stereo views are generated in a multi-view rendering mode in which a game engine alternates rendering of the scene between a left view and a right view. A graphics processing unit (GPU) conducts a single iteration through all the game objects in the scene for a culling process, and renders the game objects that successfully pass the culling process.

In some embodiments of the disclosure, the stereo views are generated in a depth image based rendering (DIBR) mode in which a left view and a depth map are used as input to generate a right view through 3D wrapping and hole filling.

In some embodiments of the disclosure, an optimization function for the rendering is operable to be enabled or disabled. In some embodiments of the disclosure, the optimization function comprises a hybrid method in which a portion of shadow areas in the scene are generated by rasterization, and another portion of the shadow areas in the scene are recalculated by a ray tracing method. In some embodiments of the disclosure, the optimization function comprises reflection area reduction which comprises:
determining whether a mesh of a game object is reflective; and
adding the mesh of the game object to the ray tracing world class when the mesh of the game object is reflective, wherein bounding volume hierarchy (BVH) for the mesh is built and rendering of ray tracing effects is performed for the mesh.

### Product Integration:

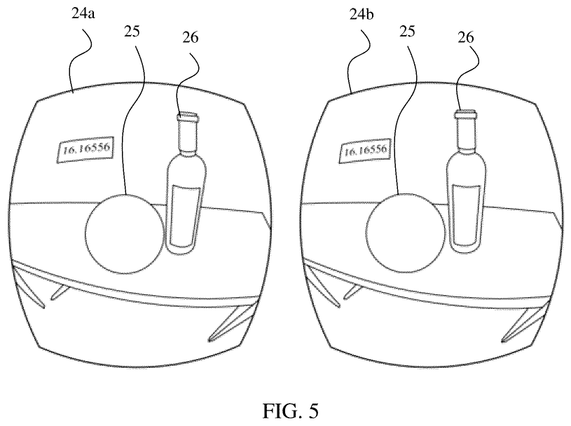

With reference to FIG. 5, an example of the native SDK 55 is provided. A native plugin 620 is an example of the native SDK 55. The example may be a sample of using the VR ray tracing system with Unity™ and Oculus™. In this scene, a ball 25 and a wine bottle 26 in the left view 24a and right view 24b are set as reflective surfaces with different metallic and roughness settings. By parsing all these information of the ball 25 and the wine bottle 26 to the native SDK 55, the reflection on surfaces of ball 25 and the wine bottle 26 is calculated. For the shadow in this scene, the system in the embodiment of the disclosure also uses a hybrid method of combining ray traced shadow and rasterized shadow to reduce complexity and computation.

### Rendering Plugin for Game Engine:

With reference to FIG. 6, an embodiment of a rendering plugin RenderingPlugin 51 is provided. The RenderingPlugin 51 works as a middle layer between scenes of game engine 50 and the native ray tracing functionalities in the system 100 (e.g., native SDK 55).

A model InitializeRTworld 601 is a function that is used to initialize the ray-tracing world in XR applications. The real-time world is a virtual environment or a virtual scene that is rendered and updated according to the user's actions and inputs. The function takes some parameters that define the properties and settings of the real-time world, such as the size, the lighting, the physics, and the objects. The function also creates and returns a handle to the ray-tracing world, which can be used to access and modify it later.

An onCamerapreRender 602 is a function that is used to execute some code before a camera that is represented by a camera object starts rendering in XR applications. It is similar to the Camera.onPreRender event in Unity™, which allows you to register a callback function that is invoked before any camera renders. The difference is that onCamerapreRender 602 is specific to each camera (e.g., camera 14a), while Camera.onPreRender is global to all cameras.

The onCamerapreRender 602 performs some operations that affect appearance or behavior of the camera or the scene before the rendering process begins. For example, the onCamerapreRender 602 can:
Adjust the camera parameters, such as the field of view, the projection matrix, or the clipping planes.
Modify the scene objects, such as changing their positions, rotations, scales, or materials.
Apply some effects, such as lens distortion, chromatic aberration, or vignetting.

An UpdateGameObject 610 is a function that is used to update properties and behaviors of a GameObject in XR applications. A GameObject is a basic unit of a scene that can represent characters, props, scenery, cameras, and more. A GameObject's functionality is defined by the components attached to it, such as scripts, renderers, colliders, and so on.

The UpdateGameObject 610 function takes a GameObject as an argument and performs some operations on it, such as changing its position, rotation, scale, material, or animation. The UpdateGameObject 610 function can be called by the onCameraPreRender 602. Alternatively, in the script attached to a GameObject, an Update method can call the UpdateGameObject 610 function every frame to make the GameObject move, rotate, or animate according to some logic or input.

A UpdateCamera 611 is a function that is used to update the properties and behaviors of a camera in XR applications. A camera is a component that captures and displays the scene from a certain point of view. A camera's functionality is defined by the parameters attached to it, such as the field of view, the projection mode, the clipping planes, and the target texture.

The UpdateCamera 611 function takes a camera as an argument and performs some operations on it, such as changing its position, rotation, zoom, or focus. The UpdateCamera 611 function can be called by the UpdateGameObject 610. Alternatively, the UpdateCamera 611 function can be called by an Update method in the script attached to the camera every frame to make the camera follow, look at, or orbit around a target object according to some logic or input.

An m_ShadowMap.Render 612 is a function that is used to render a shadow map in a game engine. A shadow map is a texture that stores the depth values of the scene from the light's point of view. A shadow map can be used to create realistic shadows by comparing the depth values of the scene from the camera's point of view with the depth values of the shadow map.

The m_ShadowMap.Render 612 function takes a light source and a scene as arguments and performs the following steps:
It creates a frame buffer object (FBO) and attaches a depth texture to it. The FBO is used to render the scene off-screen and store the depth values in the texture.
It sets the viewport size and the projection matrix according to the light source's parameters, such as the position, direction, and angle. The projection matrix defines how the scene is projected onto the texture.
It binds the FBO and clears the depth buffer. It also enables depth testing and culling of front-facing triangles to avoid self-shadowing artifacts.
It renders the scene using a shader that only outputs the depth value of each fragment. The shader can also apply some bias or offset to avoid shadow acne or light leaks.
It unbinds the FBO and restores the original viewport size and projection matrix. Thus, the depth texture is ready to be used for shadow mapping.

The m_ShadowMap.Render 612 function implementing shadow mapping. Different game engines may have different ways of rendering shadow maps, but the basic principle is similar.

A renderShadowMap 624 is operable to render shadows. The rendering involves creating a texture (called a shadow map) that stores the depth values of the scene from the perspective of a light source. Then, in the final rendering pass, the shadow map is used to determine whether a pixel is in shadow or not by comparing its depth value with the one stored in the shadow map. The renderShadowMap 624 can create realistic and dynamic shadows for various types of scenes and objects, such as trees, buildings, characters, etc.

The renderShadowMap 624 uses a stereo rendering mode that creates two images, one for each eye, with a slight horizontal offset to simulate the distance between the eyes. There are three main modes of stereo rendering:
(1). Multi-pass Rendering;
(2). Multi-view Rendering; and
(3). DIBR-based view synthesis.

A standard ORM shader is commonly used in modern game engines and 3D modeling tools that support PBR (physically based rendering) materials. PBR materials are materials that simulate how light interacts with real-world materials in a realistic way.

A standard ORM shader 641 works by using the different color channels of the texture to encode the occlusion, roughness, and metallic values. The red channel stores the occlusion, which is the amount of ambient light that reaches a surface. The green channel stores the roughness, which is the smoothness or roughness of a surface. The blue channel stores the metallic, which is the metalness or non-metalness of a surface.

The advantage of using a standard ORM shader 641 is that it reduces the number of textures needed for a material, which can improve the performance and memory usage of the application. It also makes the file management easier, as there is only one texture file per material.

A camera rendering module 642 creates realistic and immersive images for XR applications using the outputs from the standard ORM shader 641.

A ray tracing world initialization module InitializeRTWorld 601 may initialize game objects associated with a ray tracing world class RTWorld. Each game objects are represented by an object GameObject. Script (e.g., onCameraPreRender 602) that is attached to the game objects use modules in native plugin 620 to add information of the objects, cameras, materials, and lights iteratively to the RTWorld class. The native plugin 620 is included in the native SDK 55. The information includes positional matrices, characteristics of the objects, and what is required for ray tracing calculations. For example, a camera pre-rendering module onCameraPreRender 602 invokes module addMeshToRTworld 621 to add objects to the RTWorld class, invokes module addMaterialToRTworld 622 to add materials to the RTWorld class, and invokes module addLightToRTworld 623 to add lights to the RTWorld class. The module addMaterialToRTworld 622 may use material attributes of albedo, normal, orm, color, emission, roughness, and metallic in a material library 650.

A game object updating module UpdateGameObject 610 updates game objects. A camera updating module UpdateCamera 611 uses game objects to update the camera 14a.

Two customized shadow maps, which are needed for the left and right views respectively, will be created as the render target for ray tracing effects, such as shadow, reflection, refraction etc. The two customized shadow maps comprise a RayTracedShadowMap 631 for the left view 141a and a RayTracedShadowMap 632 for the right view 142a. A shadow map rendering module m_ShadowMap.Render 612 invokes a module renderShadowMap 624 to generates Ray TracedShadowMap 631 for the left view and the Ray TracedShadowMap 632 for the right view by calling the native functions in ray tracing SDK (i.e., native SDK 55) that do all the calculations for ray tracing effects, such as shadow, reflection, refraction etc. A standard object relationship mapping (ORM) shader 641 adds the shadow maps to the original scene (e.g., RTWorld) to add all the ray tracing effects.

### Stereo Vision:

The native plugin 620 performs rendering to generate the left view and right view. The native plugin 620 may drive a GPU to do the rendering.

### (1). Multi-pass Rendering:

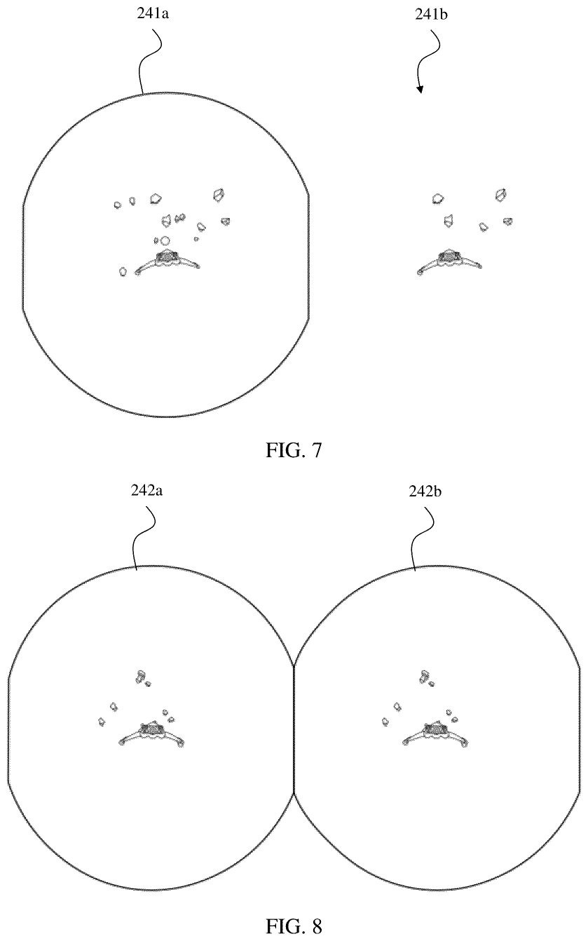

With reference to FIG. 7, an embodiment of the disclosure using multi-pass rendering is detailed in the following. The game engine 50 renders the Scene (e.g., scene 53) twice using 2 draw calls for each game object (i.e., GameObject) that has a Renderer component. The Renderer component only iterates through the Scene graph once when rendering for both the left view and right view (e.g., the left view 241a and right view 241b). The ray tracing effects are rendered on two shadow maps (e.g., RayTracedShadowMap 631 for the left view and the RayTracedShadowMap 632 for the right view) for each eye. In the multi-pass rendering scheme, the two shadow maps will be rendered to the left eye or right eye sequentially.

### (2). Multi-View Rendering:

With reference to FIG. 8, an embodiment of the disclosure using multi-view rendering is detailed in the following. During multi-view rendering, both the left view and right view (e.g., the left view 242a and right view 242b) share the work required by culling and shadow computation. Culling, such as frustum culling, occlusion culling, and level of detail (LOD) culling, is to reduce the number of objects that need to be rendered in a scene, by discarding those that are not visible to the camera. In the multi-view rendering scheme, the graphics processing unit (GPU) renders each game object (i.e., GameObject) in a ping pong fashion, alternating rendering of game objects between eyes. As a result, fewer graphics commands changes or switches states. The GPU conducts a single iteration through all the GameObjects in the Scene for a culling process, and renders the GameObjects that successfully pass the culling process. For the ray traced shadow map of the Scene, the left eye and right eye views (e.g., the left view 242a and right view 242b) are clipped into one render texture with left half and right half for each eye's view. The camera render process (i.e., camera render 642) will then fetch the combined texture only once and render unto the game objects with one draw call.

### (3). DIBR-Based View Synthesis:

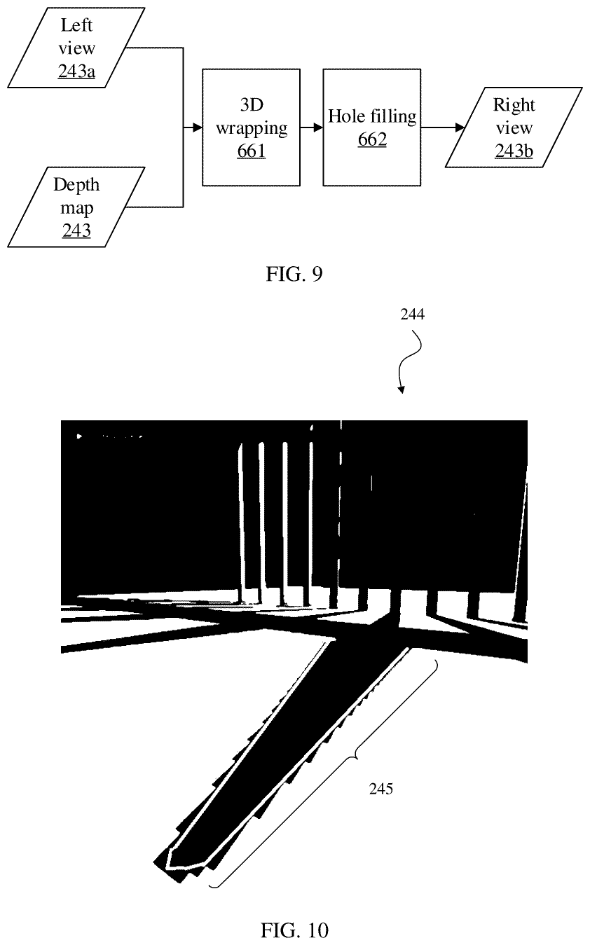

With reference to FIG. 9, an embodiment of the disclosure using a scheme of DIBR-based view synthesis is detailed in the following. To further reduce the computation for generating two shadow maps for left and right eye views, the scheme of DIBR-based view synthesis can be applied. DIBR stands for depth image based rendering, which utilizes left view (e.g., left view 243a) and a depth map (e.g., depth map 243) as input to generate right view (e.g., right view 243b) through 3D wrapping and hole filling (e.g., 3D wrapping 661 and hole filling 662). This will reduce half of the ray tracing computations and works fine on objects that are not close to a viewpoint.

### Rendering Optimization:

(1). Hybrid Rendering with Rasterization:

With reference to FIG. 10, an embodiment of the disclosure using a scheme of DIBR-based view synthesis is detailed in the following. The CPU and GPU on current VR devices are not as powerful as those on smartphones, not mentioning the latest GPUs that has specific hardware for ray tracing calculation. Hence, the system has to be simplified and adapted to achieve the goal of real-time ray tracing for virtual reality scenes. For example, some of the ray-traced effects may be partially or entirely disabled to improve efficiency. In this system, an embodiment of the disclosure provides a hybrid method to render shadows. In the hybrid method, the majority of the shadow areas in the scene are generated by rasterization. The shadow areas generated by rasterization are only hard shadow, such as the black parts in the scene 244 in FIG. 10. The zig-zagging edges (e.g., edge 245) will then be recalculated by a ray tracing method of the native plugin 620 to have better effects. Finally, the zig-zagging edges (e.g., edge 245) will be rendered with ray-traced shadows.

### (2). To Reduce Reflection Area Based on Materials:

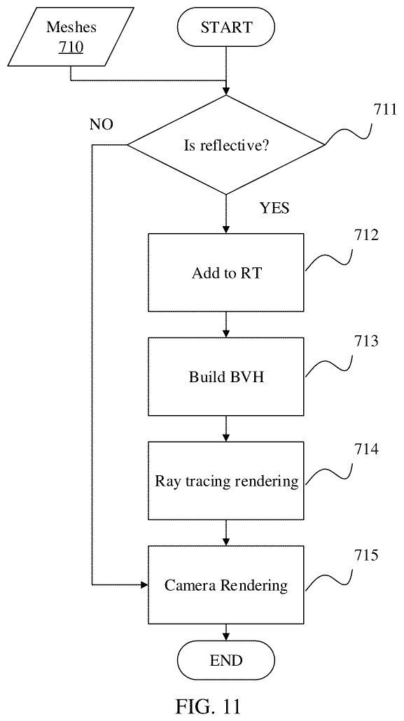

With reference to FIG. 11, an embodiment of the disclosure reducing reflection area based on materials is detailed in the following. The operations may be performed by native plugin 620. To enhance ray tracing performance on VR devices, the non-reflective game objects will not be added to the RT world, thereby omitting the non-reflective objects from the ray tracing computation. Consequently, most of the background scenes or objects remain unchanged as the original settings. The reflection condition of each game object can be either determined by the material of the object, or can be further calculated based on the physical characteristics of the object. For example, only the most metallic and smooth areas of a bottle will be considered as reflective.

As shown in FIG. 11, steps 711 and 712 can be applied to each game object. As a current game object is input a mesh 710 the system 100. The system 100 determines whether the mesh 710 is reflective (711). If the mesh 710 is not reflective, the system 100 inputs the mesh 710 for camera rendering (715). If the mesh 710 is reflective, the system 100 adds the mesh 710 to the class RTWorld (712). The system 100 builds BVH for the mesh 710 (713) and performs ray tracing rendering for the mesh 710 (714). The system 100 performs camera rendering for the game objects (715).

The operations in FIG. 11 can be executed in a GPU or the modules in the FIG. 6.

In some embodiments of the disclosure, ray tracing can also be done completely in a game engine (e.g., the game engine 50) without using the native plugin (e.g., the RenderingPlugin 51) and calling native functions (e.g., the native SDK 55).

In some embodiments of the disclosure, the native plugin (e.g., the RenderingPlugin 51) and native functions (e.g., the native SDK 55) can either be integrated into a game engine (e.g., the game engine 50) or be used as a third-party library in applications to run ray tracing effects.

In some embodiments of the disclosure, the stereo vision can be configured as left eye dominant, right eye dominant, or center view dominant to enable real-time ray tracing effects on AR/VR/MR devices.

In DIBR-based view synthesis, a left view can be used to generate right view. Alternatively, a right view can also be used to generate left view, or a center view can be used to generate a left view or right view.

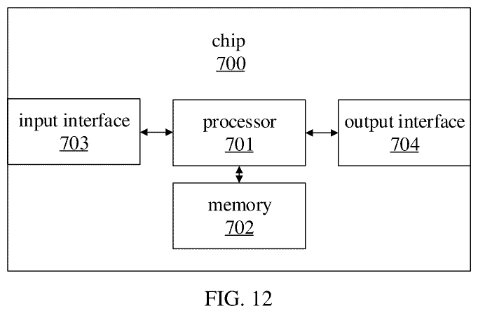

With reference to FIG. 12, the embodiment of the disclosure also provides a chip 700 that may correspond to a XR device 10a in the embodiments of the disclosure. The chip 700 may implement a corresponding process realized by the XR device 10a in various methods of the embodiments of the disclosure. The chip 700 includes a processor 701, and the processor 701 may call and run a computer program from memory to implement the methods in the embodiments of the present application.

Optionally, the chip 700 may also include a memory 702. In particular, the processor 701 may call and run the computer program from the memory 702 to implement the methods in the embodiments of the present application.

Moreover, the memory 702 may be a separate device from the processor 701 or may be integrated into the processor 701.

Optionally, the chip 700 may further include an input interface 703. Note that the processor 701 may control the input interface 703 to communicate with other devices or chips, specifically, to obtain messages or data sent by other devices or chips.

Optionally, the chip 700 may further include an output interface 704. Note that the processor 701 may control the output interface 704 to communicate with other devices or chips, specifically, to output messages or data to other devices or chips.

The described system and methodology offer a real-time solution for rendering ray tracing effects in virtual reality, augmented reality, and mixed reality applications.

The system and methodology are applicable for both all-in-one devices and PC-based or smartphone-based AR/VR/MR devices.

The system is implemented as a lightweight plugin that can be integrated in a game engine (e.g., game engine 50) to provide ray tracing effects.

The optimization methods can be manually or automatically enabled or disabled, depending on the scene complexity and computational resources.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for ray tracing for execution by an electronic device, comprising:
adding game objects to a ray tracing world class associated with a scene;
adding materials of the game objects to the ray tracing world class;
adding light configuration to the ray tracing world class;
rendering ray tracing effects for at least one portion of the game objects in the scene based on the ray tracing world class; and
generating stereo views of the scene including the game objects.

2. The method for ray tracing of claim 1, wherein the method is implemented by a software development kit (SDK) in the electronic device.

3. The method for ray tracing of claim 2, wherein the SDK is included in a game engine of the electronic device.

4. The method for ray tracing of claim 1, wherein the materials of the game object comprise albedo, normal, object relationship mapping (ORM), color, emission, roughness, and metallic.

5. The method for ray tracing of claim 1, wherein the light configuration comprises a light source.

6. The method for ray tracing of claim 1, wherein the stereo views are generated in a multi-pass rendering mode in which a game engine renders the scene twice using two draw calls for each of the game object.

7. The method for ray tracing of claim 1, wherein the stereo views are generated in a multi-view rendering mode in which a game engine alternates rendering of the scene between a left view and a right view.

8. The method for ray tracing of claim 1, wherein a graphics processing unit (GPU) conducts a single iteration through all the game objects in the scene for a culling process, and renders the game objects that successfully pass the culling process.

9. The method for ray tracing of claim 1, wherein the stereo views are generated in a depth image based rendering (DIBR) mode in which a left view and a depth map are used as input to generate a right view through 3D wrapping and hole filling.

10. The method for ray tracing of claim 1, wherein an optimization function for the rendering is operable to be enabled or disabled.

11. The method for ray tracing of claim 10, wherein the optimization function comprises a hybrid method in which a portion of shadow areas in the scene are generated by rasterization, and another portion of the shadow areas in the scene are recalculated by a ray tracing method.

12. The method for ray tracing of claim 10, wherein the optimization function comprises reflection area reduction which comprises:
adding a mesh of a game object to the ray tracing world class in response to the mesh of the game object being reflective, wherein bounding volume hierarchy (BVH) for the mesh is built and rendering of ray tracing effects is performed for the mesh.

13. An electronic device comprising:
a processor configured to call and run a computer program stored in a memory, to cause a device in which the processor is installed to;
add game objects to a ray tracing world class associated with a scene;
add materials of the game objects to the ray tracing world class;
add light configuration to the ray tracing world class;
render ray tracing effects for at least one portion of the game objects in the scene based on the ray tracing world class; and
generate stereo views of the scene including the game objects.

14. A chip, comprising:
a processor, configured to call and run a computer program stored in a memory, to cause a device in which the chip is installed to;
add game objects to a ray tracing world class associated with a scene;
add materials of the game objects to the ray tracing world class;
add light configuration to the ray tracing world class;
render ray tracing effects for at least one portion of the game objects in the scene based on the ray tracing world class; and
generate stereo views of the scene including the game objects.

15-29. (canceled)

30. The electronic device of claim 13, wherein the materials of the game object comprise albedo, normal, object relationship mapping (ORM), color, emission, roughness, and metallic; and
wherein the light configuration comprises a light source.

31. The electronic device of claim 13, wherein the device is further caused to generate the stereo views in a multi-pass rendering mode in which a game engine renders the scene twice using two draw calls for each of the game object.

32. The electronic device of claim 13, wherein the device is further caused to generate the stereo views in a multi-view rendering mode in which a game engine alternates rendering of the scene between a left view and a right view.

33. The electronic device of claim 13, further comprising: a graphics processing unit (GPU) configured to conduct a single iteration through all the game objects in the scene for a culling process, and render the game objects that successfully pass the culling process.

34. The electronic device of claim 13, wherein the device is further caused to generate the stereo views in a depth image based rendering (DIBR) mode in which a left view and a depth map are used as input to generate a right view through 3D wrapping and hole filling.

35. The electronic device of claim 13, wherein an optimization function for the rendering is operable to be enabled or disabled;
wherein the optimization function comprises at least one of:
a hybrid method in which a portion of shadow areas in the scene are generated by rasterization, and another portion of the shadow areas in the scene are recalculated by a ray tracing method; and
reflection area reduction comprising: adding a mesh of a game object to the ray tracing world class in response to the mesh of the game object being reflective, wherein bounding volume hierarchy (BVH) for the mesh is built and rendering of ray tracing effects is performed for the mesh.
